(19) United States
(12) Patent Application Publication
(10) Pub. No.: US 2018/0173981 A1
(43) Pub. Date: Jun. 21, 2018

(54) METHOD AND COMPUTER PROGRAM OF ENROLLING A BIOMETRIC TEMPLATE

(71) Applicant: PRECISE BIOMETRICS AB, Lund (SE)

(72) Inventor: Fredrik ROSQVIST, Malmö (SE)

(21) Appl. No.: 15/735,856

(22) PCT Filed: Jun. 15, 2016
(86) PCT No.: PCT/EP2016/063683

§ 371 Date: Dec. 12, 2017

(30) Foreign Application Priority Data
Jun. 16, 2015 (SE) 1550828-6

(51) Int. Cl. G06K 9/00

(52) U.S. Cl. CPC G06K 9/00926; G06K 9/00087; G06K 9/00026

(57) ABSTRACT

A method of enrolling a biometric template from a biometric sensor arranged to collect a plurality of images is disclosed. Each image comprises an elongated part of a biometric object. The collection is made upon repeated placement of the finger on the biometric sensor. The method comprises matching at least one of the collected images with at least one of the other collected images, merging images, for a match between two images fulfilling match, criteria, from the two images, including mutually aligning the two images, and repeating merging of images such that at least one merged image covers a part of the biometric object that is larger than each collected image, extracting a plurality of elongated images from the at least one merged image, wherein the orientation of the elongated images of the extracted images is perpendicular to the elongation of the collected images, and generating sub-templates both from the collected images, respectively, and the extracted images, respectively, by feature extraction and forming the biometric template from the sub-templates. A mechanism, for enrolling a biometric template and a computer program are also disclosed.

### TECHNICAL FIELD

The present invention generally relates to a method of enrolling a biometric template, a mechanism for enrolling a biometric template, and a computer program for implementing the method.

### BACKGROUND

Biometric information is usable for verification and/or authentication of an individual. It is used in many contexts, and the development of technology therefor both strives towards neat biometric readers and towards a high degree of certainty in the verification/authentication. These goals do not always go hand-in-hand. A desire to use small sensors, e.g. for small devices or for pure design matters, may not always make it easy to provide a high degree of certainty, and the other way around.

For biometric readings where there is a relation in size between the biometric object in question and the part of it enabled to be read by one reading, the sensor for performing the reading may be considered “small”, not always in absolute terms but in a relation between the image it provides and the object it images.

It is therefore a desire to provide an approach for providing an improvement for such small sensors.

### SUMMARY

An object of the invention is to at least alleviate the above stated problem. The present invention is based on the understanding that when a plurality of elongated images of a biometric object are captured to provide an aggregate biometric template, it is easier to find features with relations along the elongation than across the image. The inventor has then realized that by extracting elongated “readings” in a perpendicular direction, more and better relations between biometric features may be used for a biometric template.

According to a first aspect, there is provided a method of enrolling a biometric template from a biometric sensor arranged to collect a plurality of images. Each image comprises an elongated part of a biometric object. The collection is made upon repeated placement of the finger on the biometric sensor. The method comprises matching at least one of the collected images with at least one of the other collected images, merging images, for a match between two images fulfilling match criteria, from the two images, including mutually aligning the two images, and repeating merging of images such that at least one merged image covers a part of the biometric object that is larger than each collected image, extracting a plurality of elongated images from the at least one merged image, wherein the orientation of the elongated images of the extracted images is perpendicular to the elongation of the collected images, and generating sub-templates both from the collected images, respectively, and the extracted images, respectively, by feature extraction and forming the biometric template from the sub-templates.

Each collected image may be only merged with another image once.

The determining of which matching two images that fulfils the match criteria may comprise ranking each match, selecting a number of the pairs of images having the best ranked matches, and performing the merging for selected pairs of images having a match score exceeding a match threshold. The order of merging images may be determined from the ranking of matches.

The extracted images may have a mutual overlap. The mutual overlap between two neighbouring extracted images may be at least 20% of the area, preferably at least 30 ft/o, preferably at least 50%.

The elongated part of the biometric object may have an aspect ratio of at least 3:2, preferably at least 5:3.

The elongated images of the extracted images may have an aspect ratio of at least 2 preferably at least 5:3.

The size of the extracted images nay be larger than the size of collected images. Alternatively, the size of the extracted images may be the same as the size of collected images.

The extracting of the plurality of elongated images from the at least one merged image may comprise selecting only images having an amount of biometric object features exceeding a threshold.

The extracting of the plurality of elongated images from the at least one merged image may comprise ranking the elongated images based on their content of biometric object features, and selecting only a number of images having the highest rank of biometric object features.

The extracting of the plurality of elongated images may comprise cropping images from the at least one merged image.

The alignment between the two images may comprise a further correlation matching.

According to a second aspect, there is provided a mechanism for enrolling a biometric template from a biometric sensor arranged to collect a plurality of images, wherein each image comprises an elongated part of a biometric object, upon repeated placement of the finger on the biometric sensor. The mechanism comprises a matcher arranged to match at least one of the collected images with at least one of the other collected images, a merger arranged to merge images, for a match between two images fulfilling match criteria, from the two images, an arranged to mutually align the two images, and arranged to repeat the merge of images such that at least one merged image covers a part of the biometric object that is larger than each collected image, an extractor arranged to extract a plurality of elongated images from the at least one merged image, wherein the orientation of the elongated images of the extracted images is perpendicular to the elongation of the collected images, and a template generator arranged to generate sub-templates both from the collected images, respectively, and the extracted images, respectively, by feature extraction and forming the biometric template from the sub-templates.

Each collected image may be only merged with another image once.

The merger may be arranged to determine which matching two images that fulfil the match criteria by ranking each match, selecting a number of the pairs of images having the best ranked matches, and performing the merging for selected pairs of images having a match score exceeding a match threshold. The order of merging images may be determined from the ranking of matches.

The extracted images may have a mutual overlap. The mutual overlap between two neighbouring extracted images may be at least 20% of the area, preferably at least 30%, preferably at least 50%.

The elongated part of the biometric object may have an aspect ratio of at least 3:2, preferably at least 5:3.

The elongated images of the extracted images may have an aspect ratio of at least 3:2, preferably at least 5:3.

The size of the extracted images may be larger than the size of collected images. Alternatively, the size of the extracted images may be the same as the size of collected images.

The extractor may be arranged to, for the extraction of the plurality of elongated images from the at least one merged image, select only images having an amount of biometric object features exceeding a threshold.

The extractor may be arranged to, for the extraction of the plurality of elongated images from the at least one merged image, rank the elongated images based on their content of biometric object features, and select only a number of images having the highest rank of biometric object features.

The extractor may be arranged to, for the extraction of the plurality of elongated images, crop images from the at least one merged image.

The alignment between the two images may comprise a further correlation matching.

According to a third aspect, there is provided a computer program comprising instructions which, when executed on a processor of a mechanism for enrolling a biometric template, causes the mechanism to perform the method according to the first aspect.

An example of a biometric object may be a fingerprint, and an example of a biometric reader may be a fingerprint reader.

Other objectives, features and advantages of the present invention will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings.

FIGS. 1 to 5 illustrate a basic principle of enhanced template forming.

FIG. 6 schematically illustrates a mechanism according to an embodiment for enrolling a biometric template.

FIG. 7 is a flow chart schematically illustrating methods according to embodiments.

FIG. 8 schematically illustrates a computer-readable memory comprising computer program code, and a processor arranged to execute the computer program code.

### DETAILED DESCRIPTION

FIGS. 1 to 5 illustrate the basic principle of the enhanced template forming. The reader is considered to have basic skills within image processing, feature extraction of biometric features, and biometric matching, and details thereof are therefore left out not to obscure the gist of the principle and its contribution within the art. Furthermore, the approach is mainly described in the context of fingerprint readings from a sensor capturing only a part of what is normally considered the entire fingerprint, i.e. the image of one side of the finger from the distal joint of the finger to the fingertip. However, the approach may be used also for other biometric objects where there is a relation in size between the biometric object in question and the part of it enabled to be read by one reading. Such examples may be hand, foot, face, etc. and the image may also include features which the human eye cannot perceive, such as vein patterns, etc.

FIG. 1 illustrates that a plurality of images are captured. The images comprise an elongated part of a fingerprint. Elongated in this sense means that they have an aspect ratio of for example at least 3:2, preferably at least 5:3. For example, the sensor providing the image may have the dimension 10 mm by 4 mm, i.e. an aspect ratio of 5:2. As will be understood from this elucidation of the principle, the effect of the approach comes with the elongated images since biometric information used in for example matching or identification using the formed template is based on mutual physical relations between features provided at shorter or longer distances from each other. An elongated image provides a sub-template providing features with mutual relations within one direction of the sub-template, while relations in the perpendicular direction is limited due to the shorter available distance. As will be seen below, forming of an additional set of images and thus sub-templates having an essentially perpendicular direction, where essentially perpendicular concerns the rotation provided by alignment of the collected images, wherein mutual relations between features are not constrained in the same direction as the sub-templates based on the collected images. In aggregation, this provides for an enhanced template enabling more efficient matching or identification from a biometric reading such as a fingerprint.

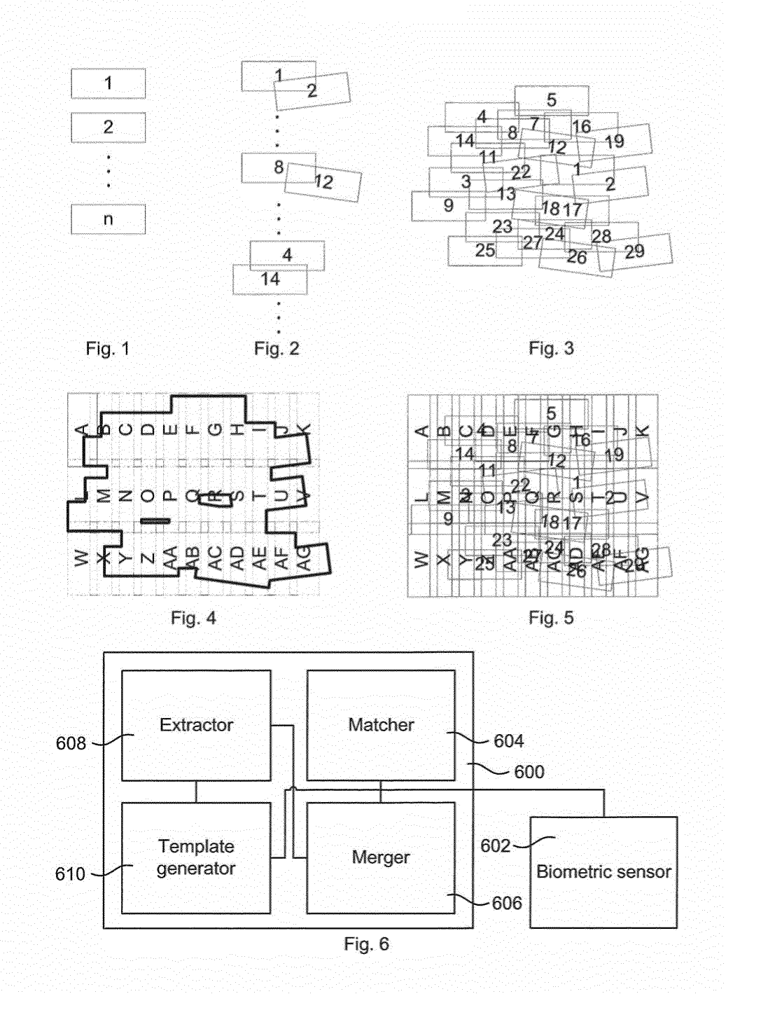

FIG. 2 illustrates matching each of a plurality of the collected images with at least one of the other collected images, wherein images which overlap the same part of the fingerprint is supposed to provide a match. Here, some collected images may be left out from the matching, e.g. being discarded due to low image quality. The matching result may be stored in a matrix holding match scores for the respective comparisons of images. Images that do not overlap will thus have no or low (due to stochastic errors) score. Images that overlap will get higher scores and images that overlap to a significant degree and that have decent image quality will get high scores. Such images have good possibility of being mutually aligned with good accuracy. The scores may thus be used for decisions for efficient aligning of images and merging them to an aggregate image as will be shown with reference to FIG. 3. For example, the scores may be ranked, wherein only the best scores, i.e. best matches, are used for building the aggregate image. Each used image for building the image is only used once to avoid ghost images from the same image. For example, by using the rank and building the aggregate image in rank order, this may be safeguarded. Aggregated images, e.g. aggregates from two images, are subject for pairing with other images, e.g. a collected image or other aggregated images. An image as illustrated in FIG. 3 is thus formed from the collected images denoted with Nos 1, 2, . . . . Some of the collected images may not have been able to fit in with the aggregate image, and are thus discarded from the aggregation. In some cases, not only one aggregated image is formed; two or more “islands” may be formed, wherein the mutual relation between the islands are unknown since no reliable match has been found. In such cases, the two or more islands may be processed the same way as described herein for a single aggregated image.

Here, is may be noted that at least for the collected images that have been used for the aggregate image(s) may form basis for sub-templates, wherein features are extracted etc. according to a traditional approach therefore.

It is a benefit if a high-quality aggregate image is formed at the merging. As an additional enhancement, alignment between the images comprises a further correlation matching, e.g. on a pixel level.

FIG. 4 illustrates, by the bold line, the formed aggregate image. FIG. 4 also illustrates n example of extraction of a plurality of elongated images from the merged image, wherein the orientation of the elongated images of the extracted images is essentially, considering the aligning of the collected images, perpendicular to the elongation of the collected images. The method extracted images preferably have a mutual overlap, since this better takes features close to borders of the extracted images into account. The mutual overlap between two neighbouring extracted images may be chosen to be at least 20% of the area. A large overlap will produce more extracted images for covering an aggregated image, but if this is not a severe constraint, the overlap may be chosen to be for example at least 30%, or even at least 50%. The elongated images of the extracted images may have an aspect ratio corresponding to that of the collected images, but need not be the same. The aspect ratio is preferably at least 3:2, preferably at least 5:3. The size of the extracted images may be the same as the size as the collected images, but it has been seen that an improvement in performance is gained when the size of the extracted images is slightly larger than the size of collected images. When the extracted images, denoted A, B, . . . , has been formed, e.g. by cropping images from the aggregate image, a selection among the formed images may be performed. For example, only images having an amount of fingerprint features exceeding a threshold may be selected and/or ranking the elongated images based on their content of fingerprint features, and selecting only a number of images having the highest rank of fingerprint features. Sub-templates are then formed by feature extraction etc. according to a traditional approach therefore from the extracted (and possibly selected) elongated images.

Two sets of images and thus two sets of sub-templates are thus provided, as is illustrated in FIG. 5. Here, it is to be noted that all of the illustrated sub-templates may not be selected for forming the biometric template. For example, it can be seen from FIG. 5 that extracted sub-templates A, K, L, V, W and X are not likely to contain very much information since they are extracted at areas where no or very little image information is available, and they do not likely contain features enough for being reasonable to keep. There may also be other reasons for not selecting a sub-template, as discussed above. There may also be a system constraint where only a limited amount of sub-templates are possible to store for the biometric template. The selection may comprise some algorithm for efficient utilization of the storage capacity. For example, the approach demonstrated in International patent application No. PCT/EP2014/077071 may be applied. From these sub-templates, the biometric template is formed, and may for example be used for matching and/or identification.

FIG. 6 schematically illustrates a mechanism 600 according to an embodiment for enrolling a biometric template from a biometric sensor 602. The biometric sensor 602 and the mechanism 600 are arranged to collect a plurality of images, wherein each image comprises an elongated part of a biometric object, upon repeated placement of the finger on the biometric sensor 602. The mechanism 600 comprises a matcher 604, a merger 606, an extractor 608 and a template generator 610. The matcher 604 receives the collected images and is arranged to match at least one of the collected images with at least one of the other collected images, as demonstrated above. The merger 610 receives matching results from the matcher 604 and is arranged to merge images, based on the match between two images. The merger 606 mutually aligns the two images, and repeats the merge of images, i.e. both collected images and images formed by earlier merging. Thereby, at least one merged image covers a part of the biometric object that larger than the respective collected images. The extractor 608 receives the merged image(s) and extracts a plurality of elongated images, as demonstrated above with reference to FIG. 4. The orientation of the elongated images acquired by the extraction is essentially perpendicular to the elongation of the collected images, wherein the expression “perpendicular” is not to be construed in, absolute terms, as discussed above. The template generator 610 receives the extracted images and the collected images together with their information regarding position and alignment to generate sub-templates from them. This is performed by feature extraction wherein the forming of the biometric template is made from the sub-templates.

The information provided between these elements 604, 606, 608, 610, and their division of the tasks may be modified, and one or more of the elements may be integrated with one or more of the other elements. One practical implementation may be to provide the elements as program objects interacting with each other, and the skilled reader then realizes that division into more or fewer objects is a matter of design option, but the overall structure will resemble the one demonstrated above.

The respective elements are arranged to perform the approach demonstrated above with reference to FIGS. 1 to 5, and for the sake of conciseness, it is not further elucidated here.

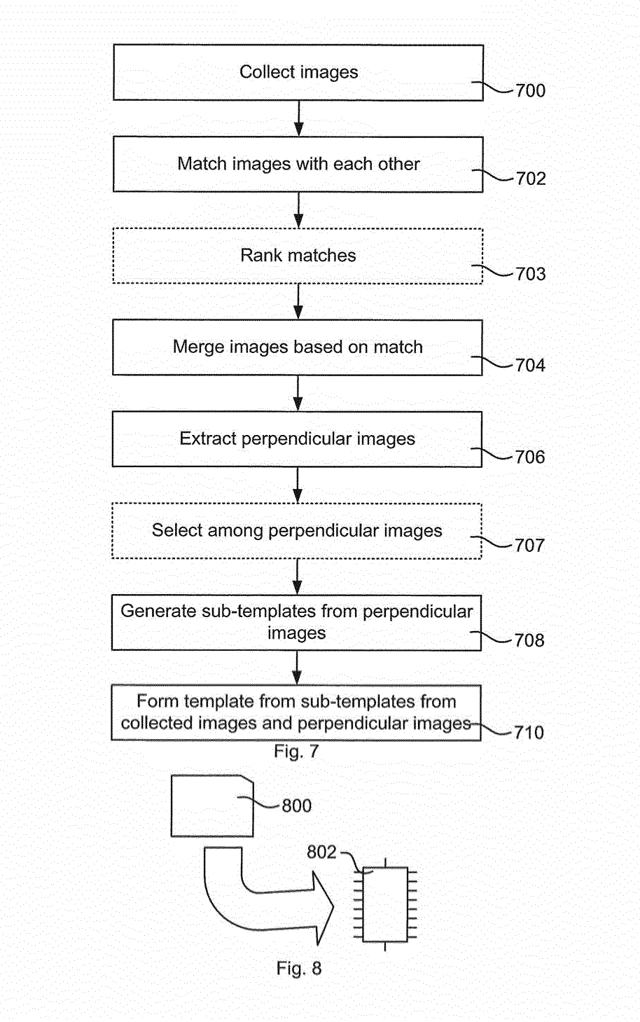

FIG. 7 is a flow chart schematically illustrating methods according to embodiments. Images are collected 700 from a biometric sensor providing elongated images. The images are matched 702 with each other. The matches may be ranked 703 for making the further processing more efficient, e.g. to select which images, and/or in which order to process them. Images are then merged 704 based on whether they match, and the images that are merged are aligned to each other. This may optionally include a further correlation matching, e.g. on a pixel level, to accurately align the images. The merging involves both collected images, which preferably only are added once, and images formed by merging. Thus, one or more larger merged image will be formed. In an ideal situation, only one large merged image is formed showing the entire fingerprint. From the one or more merged images, perpendicular elongated images, preferably at least as large as the collected images and with at least a certain overlap, are extracted 706 from the one or more merged images, e.g. by cropping out the respective elongated images. The extracted images are perpendicular in that sense that the elongation is essentially perpendicular to the elongation of the collected images. Not all the extracted images contain usable image information from which features may be extracted. A selection 707 may therefore be performed where usable images are selected. Sub-templates are generated 708 from the extracted images, as well as from collected images. Also the collected images may be subject to selection. This selection is preferably performed, at least to some degree, after the matching and merging since some of the collected images may be usable for the alignment and merging although the for example do not contain a usable amount of features to extract. Some of the collected images may of course be of such low quality such that they may be discarded prior any further processing. Two sets of sub-templates are now formed, and a biometric template to be used for e.g. authentication and/or verification is formed 710 from the sub-templates of the sets.

The methods according to the present invention are suitable for implementation with aid of processing means, such as computers and/or processors, especially for the case where the mechanism is implemented by one or more processors. Therefore, there is provided computer programs, comprising instructions arranged to cause the processing means, processor, or computer to perform the steps of any of the methods according to any of the embodiments described with reference to FIG. 7. The computer programs preferably comprises program code which is stored on a computer readable medium 800, as illustrated in FIG. 8, which can be loaded and executed by a processing means, processor, or computer 802 to cause it to perform the methods, respectively, according to embodiments of the present invention, preferably as any of the embodiments described with reference to FIG. 7. The computer 802 and computer program product 800 can be arranged to execute the program code sequentially where actions of the any of the methods are performed stepwise. The processing means, processor, or computer 802 is preferably what normally is referred to as an embedded system. Thus, the depicted computer readable medium 800 and computer 802 in FIG. 8 should be construed to be for illustrative purposes only to provide understanding of the principle, and not to be construed as any direct illustration of the elements.

A particular advantage of the above disclosed approach is when a biometric reading, using an elongated sensor, for matching with the enrolled template happens to be made with a large angle, e.g. essentially perpendicular, to the angle of the readings made at the enrolment, there is a greater chance of getting a proper correlation and thus proper score when performing the matching. This is due to the greater chance of overlapping areas of the read fingerprint and what is represented by the sub-template.

The invention has mainly been described, above with reference to a few embodiments. However, as is readily appreciated by a person skilled in the art, other embodiments than the ones disclosed above are equally possible within the scope of t invention, as defined by the appended patent claims.

1. A method of enrolling a biometric template from a biometric sensor arranged to collect a plurality of images, wherein each image comprises an elongated part of a biometric object, upon repeated placement of the finger on the biometric sensor, the method comprising
matching at least one of the collected images with at least one of the other collected images;
merging images, for a match between two images fulfilling match criteria, from the two images, including mutually aligning the two images, and repeating merging of images such that at least one merged image covers a part of the biometric object that is larger than each collected image;
extracting a plurality of elongated images from the at least one merged image, wherein the orientation of the elongated images of the extracted images is [essentially] perpendicular to the elongation of the collected images;
generating sub-templates both from the collected images, respectively, and the extracted images, respectively, by feature extraction and forming the biometric template from the sub-templates.

2. The method of claim 1, wherein each collected image is only merged with another image once.

3. The method of claim 1, wherein determining which matching two images fulfils the match criteria comprises
ranking each match;
selecting a number of the pairs of images having the best ranked matches; and
performing the merging for selected pairs of images having a match score exceeding a match threshold.

4. The method of claim 3, wherein the order of merging images is determined from the ranking of matches.

5. The method of claim 1, wherein the extracted images have a mutual overlap.

6-8. (canceled)

9. The method of claim 1, wherein the size of the extracted images is larger than the size of collected images.

10. The method of claim 1, wherein the size of the extracted images is the same as the size of collected images.

11. The method of claim 1, wherein the extracting of the plurality of elongated images from the at least one merged image comprises selecting only images having an amount of biometric object features exceeding a threshold.

12. The method of claim 1, wherein the extracting of the plurality of elongated images from the at least one merged image comprises ranking the elongated images based on their content of biometric object features, and selecting only a number of images having the highest rank of biometric object features.

13. The method of claim 1, wherein the extracting of the plurality of elongated images comprises cropping images from the at least one merged image.

14. (canceled)

15. A mechanism for enrolling a biometric template from a biometric sensor arranged to collect a plurality of images, wherein each image comprises an elongated part of a biometric object, upon repeated placement of the finger on the biometric sensor, wherein the mechanism comprises
a matcher arranged to match at least one of the collected images with at least one of the other collected images;
a merger arranged to merge images, for a match between two images fulfilling match criteria, from the two images, an arranged to mutually align the two images, and arranged to repeat the merge of images such that at least one merged image covers a part of the biometric object that is larger than each collected image;
an extractor arranged to extract a plurality of elongated images from the at least one merged image, wherein the orientation of the elongated images of the extracted images is perpendicular to the elongation of the collected images; and
a template generator arranged to generate sub-templates both from the collected images, respectively, and the extracted images, respectively, by feature extraction and forming the biometric template from the sub-templates.

16. The mechanism of claim 15, wherein each collected image is only merged with another image once.

17. The mechanism of claim 15, wherein the merger is arranged to determine which matching two images that fulfil the match criteria by
ranking each match;
selecting a number of the pairs of images having the best ranked matches; and
performing the merging for selected pairs of images having a match score exceeding a match threshold.

18. The mechanism of claim 17, wherein the order of merging images is determined from the ranking of matches.

19. The mechanism of claim 15, wherein the extracted images have a mutual overlap.

20-22. (canceled)

23. The mechanism of claim 15, wherein the size of the extracted images is larger than the size of collected images.

24. The mechanism of claim 15, wherein the size of the extracted images is the same as the size of collected images.

25. The mechanism of claim 15, wherein the extractor is arranged to, for the extraction of the plurality of elongated images from the at least one merged image, select only images having an amount of biometric object features exceeding a threshold.

26. The mechanism of claim 15, wherein the extractor is arranged to, for the extraction of the plurality of elongated images from the at least one merged image, rank the elongated images based on their content of biometric object features, and select only a number of images having the highest rank of biometric object features.

27. The mechanism of claim 15, wherein the extractor is arranged to, for the extraction of the plurality of elongated images, crop images from the at least one merged image.

28. (canceled)

29. A computer program comprising instructions which, when executed on a processor of a mechanism for enrolling a biometric template, causes the mechanism to perform the method according to claim 1.
